(19) United States
(12) Patent Application Publication
(10) Pub. No.: US 2025/0212047 A1
(43) Pub. Date: Jun. 26, 2025

(54) PROVIDING IMPROVED CALL QUALITY FOR OVER THE TOP SERVICES USING 5G NETWORK CAPABILITIES

(71) Applicant: DISH Wireless L.L.C., Englewood, CO (US)

(72) Inventors: Mehdi ALASTI, Arlington, VA (US); Siddhartha CHENUMOLU, Ashburn, VA (US); Kazi BASHIR, Lewisville, TX (US)

(73) Assignee: DISH Wireless L.L.C., Englewood, CO (US)

(21) Appl. No.: 18/395,052

(22) Filed: Dec. 22, 2023

(51) Int. Cl. H04W 28/02; H04W 24/08

(52) U.S. Cl. CPC H04W 28/0268; H04W 24/08

(57) ABSTRACT

Providing improved call quality for over-the-top (OTT) services using Fifth Generation (5G), Sixth Generation (6G), or any future wireless network capabilities is disclosed. 5G wireless networks, for example, support an advanced quality of service (QoS) framework with different QoS attributes and priorities. An OTT application and a service type (e.g., voice call, video, group communications, etc.) can be detected and an appropriate high quality QoS flow can be assigned for that service. The OTT service can thus have high quality even when the network is congested.

### FIELD

The present invention generally relates to communications, and more specifically, to providing improved call quality for over-the-top (OTT) services using Fifth Generation (5G), Sixth Generation (6G), or any future wireless network capabilities.

### BACKGROUND

Legacy telecommunications services include voice calls and text messages (i.e., Short Message Service (SMS)). OTT messages, however, are sent using data or the Internet Protocol (IP) of the cellular provider/Wireless Local Area Network (WLAN) rather than using traditional Short Message Service (SMS) infrastructure. OTT messages still require use of the cellular provider's core when sent via cellular.

Many users are switching to OTT applications for communications (e.g., WhatsApp®, Telegram®, Signal®, etc. These OTT applications not only handle voice calls and text messages, but also video calls, group communications, smart messaging, free international calls, etc. Typically, OTT client applications communicate through an OTT server. Each leg in the communications chain has secure connectivity to the OTT server that connects to the OTT subscribers.

There are various OTT applications that subscribers can pick and use depending on the desired features. However, OTT applications do not handle emergency calls and they rely on best effort Internet connectivity. In other words, they are treated like data. Accordingly, an improved and/or alternative approach may be beneficial.

### SUMMARY

Certain embodiments of the present invention may provide solutions to the problems and needs in the art that have not yet been fully identified, appreciated, or solved by current communications technologies, and/or provide a useful alternative thereto. For example, some embodiments of the present invention pertain to providing improved call quality for OTT services using 5G, 6G, or any future wireless network capabilities.

In an embodiment, one or more non-transitory computer-readable media store one or more computer programs for providing one or more quality of service (QoS) flows for OTT applications. The one or more computer programs are configured to cause at least one processor to monitor packets from an OTT application executing on a mobile device and determine that the monitored packets pertain to the OTT application and a service type. The one or more computer programs are also configured to cause at least one processor to create and/or assign one or more QoS flows to the OTT application, the mobile device, or both, based on the determined OTT application and service type. The one or more created and/or assigned QoS flows have a higher QoS than an originally assigned QoS flow for OTT data for the mobile device.

In another embodiment, one or more computing systems include memory storing computer program instructions for providing one or more QoS flows for OTT applications and at least one processor configured to execute the computer program instructions. The computer instructions are configured to cause the at least one processor to monitor packets from an OTT application executing on a mobile device by a User Plane Function (UPF) that utilizes Deep Packet Inspection (DPI) on the monitored packets to determine patterns and characteristics of communications to and/or from the OTT application. The computer instructions are also configured to cause the at least one processor to determine, by the UPF, that the monitored packets pertain to the OTT application and a service type. The computer instructions are further configured to cause the at least one processor to create and/or assign one or more QoS flows to the OTT application, the mobile device, or both, based on the determined OTT application and service type. The one or more created and/or assigned QoS flows have a higher QoS than an originally assigned QoS flow for OTT data the mobile device.

In yet another embodiment, a computer-implemented method for providing one or more QoS flows for OTT applications includes monitoring packets from an OTT application executing on a mobile device, by a UPF. The computer-implemented method also includes determining that the monitored packets pertains to the OTT application and a service type, by the UPF. The computer-implemented method further includes creating and/or assigning one or more QoS flows to the OTT application, the mobile device, or both, based on the determined OTT application and service type, by an a Session Management Function (SMF) using one or more Service Data Flow (SDF) templates based on policy information from a Policy Control Function (PCF). The one or more created and/or assigned QoS flows have a higher QoS than an originally assigned QoS flow for OTT data the mobile device. The one or more created and/or assigned QoS flows provide a guaranteed packet latency, packet drop rate, and packet priority. The UPF, the SMF, and the PCF are executing on one or more computing systems of a network core.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a telecommunications and OTT application infrastructure system.

FIG. 2 is an architectural diagram illustrating a telecommunications and OTT application infrastructure system configured to guarantee a QoS flow, according to an embodiment of the present invention.

FIG. 3A is an architectural diagram illustrating network elements for providing high QoS flows for OTT applications, according to an embodiment of the present invention.

FIG. 3B is an architectural diagram illustrating network elements for requesting high QoS flows for OTT applications, according to an embodiment of the present invention.

FIG. 4 illustrates a high QoS handover scenario, according to an embodiment of the present invention.

FIG. 5A is a flow diagram illustrating a process for providing high QoS flows for OTT applications, according to an embodiment of the present invention.

FIG. 5B is a flow diagram illustrating a process for requesting high QoS flows for OTT applications, according to an embodiment of the present invention.

FIG. 6A illustrates an example of a neural network that has been trained to assist with determining OTT service types for providing appropriate QoS flows for OTT applications, according to an embodiment of the present invention.

FIG. 6B illustrates an example of a neuron, according to an embodiment of the present invention.

FIG. 7 is a flowchart illustrating a process for training AI/ML model(s), according to an embodiment of the present invention.

FIG. 8 is an architectural diagram illustrating a computing system configured to perform aspects of providing high quality QoS flows for OTT applications, according to an embodiment of the present invention.

FIG. 9 is a flowchart illustrating a process for providing high QoS flows for OTT applications, according to an embodiment of the present invention.

FIG. 10 is a flowchart illustrating a process for requesting high QoS flows for OTT applications, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to providing improved call quality for OTT services using 5G, 6G, or any future wireless network capabilities. 5G wireless networks, for example, support an advanced quality of service (QoS) framework with different QoS attributes and priorities. Currently, OTT applications rely on high speed Internet connection, which has the lowest priority in 5G, but their performance degrades during periods of high network congestion. Also, their performance suffers if a high speed Internet connection is not available. Due to the trend towards OTT services, in some embodiments, it is expected that 5G operators will wish to provide a high quality link between an OTT client and the OTT server for some types of subscribers and enterprise customers. This allows the OTT service to have high quality even when the network is congested.

The 5G QoS framework is end-to-end and delivers high quality OTT service with guaranteed packet latency, packet drop, etc. regardless of whether at the cell edge or the network is congested. Specific latency, packet loss, priority, etc. can be provided as compared to Internet communications, for example. Network slicing and network exposure are used to provide high quality OTT service in some embodiments. Generally speaking, network slicing refers to separating traffic into multiple logical networks that share a common physical infrastructure. Network slicing may be performed to address resource isolation, security concerns, to optimize the configuration and the network topology differently for different services, to enable differentiation between operator service offerings (e.g., to provide different levels of QoS), etc.

In Third Generation Partnership Project (3GPP) specifications, a network slice consists of a radio network and a core network. Some parts of the network resources may be shared across multiple network slices, while others may be unique to a single slice. 5G slicing may also include resource partitioning in the radio network per slice. In 5G, one mobile device may connect to more than one slice simultaneously (up to 8 slices at a given time), which was not supported in the Evolved Packet Core (EPC) architecture of 4G.

A specific network slice is defined by a parameter called Single Network Slice Selection Assistance Information (S-NSSAI). S-NSSAI can include two sub-parameters—the Slice/Service Type (SST) and the optional Slice Differentiator (SD). SD is used to differentiate between multiple slices having the same type (i.e., having the same SST).

The radio network (i.e., Radio Access Network (RAN)) serving the mobile device uses one or more S-NSSAI values requested by the mobile device to do the initial selection of that Access and Mobility Management Function (AMF). The selected AMF will decide to serve the specific mobile device, make a new slice selection itself, or use the Network Slice Selection Function (NSSF). The NSSF supports the selection of network slices based on a combination of S-NSSAI values defined by the network, requested by the mobile device, and allowed in the subscription for the mobile device.

Individual slices may have various configurations. For instance, in one example, a slice may have its own AMF, Session Management Function (SMF), and User Plane Function (UPF). In another example, multiple slices may have their own SMF and UPF, but share an AMF.

The functionality of the UPF is controlled by the SMF. The UPF interacts with internal and external IP networks and acts as an anchor point for the mobile device towards external networks, hiding the mobility. This means that an IP address of a specific mobile device Protocol Data Unit (PDU) session is routable to the UPF that serves the mobile device and the session.

The UPF processes and forwards user data, and more specifically, is responsible for routing and forwarding user plane packets between the gNB and the external data network. Uplink packets arriving from the gNB use a General Packet Radio Services (GPRS) Tunneling Protocol User Plane (GTP-U) tunnel to reach the UPF. The UPF removes the packet headers belonging to the GTP-U tunnel before forwarding the packets into the external data network. Since the UPF may provide connectivity towards multiple data networks, the UPF should ensure that packets are forwarded towards the correct network. Each GTP-U tunnel belongs to a specific PDU session, and each PDU session is setup towards a specific Data Network Name (DNN). The DNN identifies the external network to which the user plane packets should be forwarded. Thus, the UPF keeps a record of the mapping between the GTP-U tunnel, the PDU session, and the DNN.

Downlink packets arriving from the external data network are mapped onto specific QoS flows belonging to specific PDU sessions before forwarding towards the appropriate gNB. A QoS flow corresponds to a stream of packets that have an equal QoS, and a single PDU session can have multiple QoS flows. The UPF receives from a set of Service Data Flow (SDF) templates from the SMF during the setup of the PDU session and uses these templates to map each downlink packet onto a specific QoS flow. SDF templates provide a set of rules for this mapping process and are generated by the SMF from information provided by the Policy Control Function (PCF). The SDF templates in some embodiments have the appropriate rules to map OTT application packets to the correct QoS flow(s).

After the UPF identifies the appropriate QoS flow for a packet using the SDF templates, the UPF forwards the packets across the GTP-U tunnel belonging to the parent PDU session. It should be noted that there is one GTP-U tunnel per PDU session rather than one GTP-U tunnel per QoS flow. The UPF marks the GTP-U header to indicate the QoS flow associated with each packet (i.e., the QoS Flow Identity (QFI)). The Differentiated Services Code Point (DSCP) field within the IP header can be used for this purpose. In some embodiments, the mapping of a packet to a QoS flow is based on 5-tuples, including the IP addresses, the port numbers, and the DSCP.

The UPF performs various types of processing of the forwarded data. The UPF generates charging data and traffic usage reports and performs DPI. The UPF also executes on various network or user policies, such as enforcing gating, redirection of traffic, applying different data rate limitations, etc. When a mobile device is in an idle state and not immediately reachable by the network, the traffic sent towards the mobile device is buffered by the UPF, which triggers a page from the network to force the mobile device to go back to a connected state and receive the buffered data. In other words, the UPF is responsible for notifying the SMF when downlink data arrives for a mobile device that is in an idle state, as well as for triggering the page to connect the mobile device.

The 5G core UPF can be employed in series, where one UPF is distributed towards the edge of the network and the other UPF is located in a more central network site (e.g., a Regional Data Center (RDC)). Network rules can then be used to control the traffic forwarding of the distributed UPF closer to the network edge. Classification of the data packets coming from the mobile device (uplink packets) can be applied to determine whether the data should be sent out onto a local, distributed IP network or whether the data packets should be forwarded to the centralized UPF.

The UPF can also apply QoS marking of packets towards the RAN or towards external networks. The QoS marking can be used by the transport network to handle each packet with the right priority in the case of network congestion, for example. Appropriately marked packets may be used to provide the high QoS flow(s) for OTT applications discussed herein.

A 5G provider may decide to expose its 5G core network through the Network Exposure Function (NEF). The NEF supports interaction with external applications, exposing network capabilities that can be used in various ways by these applications. Some functions that may be available via the NEF provide monitoring network events associated with mobile devices, provisioning, and policy and charging control.

Some embodiments use features of 5G wireless technology to detect an OTT service, establish an appropriate high quality QoS flow, and map the OTT service to the high quality QoS flow. Patterns for the OTT application may be detected to provide the appropriate QoS. Deep Packet Inspection (DPI) at the User Plane Function (UPF) may be performed to determine such patterns and characteristics. The appropriate Application Programming Interfaces (API(s)) may then be called to make the appropriate adjustments. In essence, the changes that are occurring between a mobile device and an application server for the OTT application are detected.

The API is a call outside of the 5G core network. Some entity outside the network uses the API to try to obtain better service. The API call is made to change the mobile device QoS profile.

DPI adds IP traffic analytics capabilities to network analytics, traffic management, and network security solutions. DPI classifies thousands of applications and protocols, provides content and metadata extraction, and delivers crucial information from IP traffic based on metrics, heuristics, and behavior. DPI can be used to detect, inspect, and control the traffic on virtualized network slices in real time. DPI can be used to provide agile provisioning and fast, efficient enforcement of policies. A consistently high QoS can be provided, and DPI can monitor and control traffic on the level of individual subscribers and applications, even if that traffic is encrypted.

The features used by some embodiments may include, but are not limited to, the 5G Application Identifier (App ID), DPI (able to determine the appropriate flow quality in most cases), the 5G QoS framework, the 5G NEF, the 5G flexible API framework, and 5G mobility. Such features and other features available in 6G networks and other future technologies may also be used. 5G enhanced mobility can be used to provide guaranteed delivery of quality OTT even during handovers. During a handover, there could be extra packet latency, packet drop, or call drop due to limited resources in the target cell. The 5G enhanced mobility guarantees delivery of high quality OTT to the consumer.

In some embodiments, the process begins with detecting the OTT application. The 5G App ID may provide an indication to the network of what the OTT application is (e.g., WhatsApp®, Telegram®, Signal®, etc.). The service IP address(es) and port number(s) can also be used for detecting the OTT application. DPI can also help to detect the type of the OTT application.

Telegram® uses the MTProto 2.0 protocol for both server client encryption and end-to-end encryption. Before a message (or a multi-part message) is transmitted over a network using a transport protocol, it is encrypted in a certain way, and an external header is added at the top of the message that consists of a 64-bit key identifier auth_key_id that uniquely identifies an authorization key for the server and the user and a 128-bit message key msg_key. Signal® uses the Double Ratchet algorithm, which is used by two parties to exchange encrypted messages based on a shared secret key. The parties derive new keys for every Double Ratchet message so that earlier keys cannot be calculated from later ones. The parties also send Diffie-Hellman public values attached to their messages. The results of Diffie-Hellman calculations are mixed into the derived keys so that later keys cannot be calculated from earlier ones.

For data transmission, WhatsApp® uses an open and free protocol called Extensible Messaging and Presence Protocol (XMPP) as the messaging protocol for its platform. XMPP is based on XML and allows exchanging text messages, audio/video data, and files. XMPP is an open standard for real-time communication, which is used for instant messaging and online presence detection. WhatsApp® uses a modified version of XMPP, which is optimized for mobile devices and low-bandwidth networks. The XMPP protocol is responsible for facilitating the exchange of messages between users and for handling other features such as group chat, voice and video calls, and file sharing.

WhatsApp® operates on Transmission Control Protocol (TCP) ports 443, 4244, 5222, 5223, 5228, and 5242 and on User Datagram Protocol (UDP) port 3478. WhatsApp® UDP packets contact Session Traversal Utilities for Network Address Translation (NAT) servers (i.e., STUN servers) at IP addresses 31.13.78.51, 31.13.79.52, 157.240.7.51, 157.240.13.51, 157.240.16.51, and 157.240.23.52. Signal® uses TCP port 443 and all UDP ports. Telegram® uses default TCP ports 80, 443, and 5222 and UDP ports 1400, 40317, and 56110.

The 5G network detects the type of OTT service, which may be a voice call, a video, a group communication, text messaging, etc. Since the OTT traffic is encrypted, DPI behavioral analysis can help to detect the type of service. DPI uses analytics to detect the type of the service, along with the bit rate of the encoder. This detection process is not perfect and there is some probability of false detection. In some embodiments, artificial intelligence/machine learning (AI/ML) may be used to learn characteristics of each OTT application type and perform classification. The bit rate of voice and video calls may also be detected, for example. After the OTT application, OTT service, and bit rate are identified, the 5G network establishes the appropriate QoS flow(s) for the OTT application and maps the OTT application communications to the OTT flow(s) instead of an Internet flow. Establishment of the QoS flow(s) can be initiated through an API or the 5G core. The API may be based on a NEF that can initiate establishment of new QoS flow(s) as needed (e.g., 500 kilobits per second (kbps)), update the QoS attributes via the API, and do handover to route the traffic from the Internet to the established QoS flow(s). Changes may be made from the network core through the RAN all the way to the mobile device. In other words, the 5G QoS framework is used to setup an end-to-end QoS flow.

In some cases, a customer or an enterprise may decide to temporarily update their QoS and charging policies. This process is initiated by an API and through an NEF, or by a client application on the device requesting an API. In some embodiments, a similar approach may be used to create a QoS flow. The DPI in the UPF detects the OTT service, and through an API/NEF/PCF, triggers creation of the QoS flow.

In some embodiments, the 5G network allows the subscriber to upgrade the QoS attributes through an API if higher performance is requested. This service may be provided for an additional charge. The OTT applications, such as WhatsApp®, Telegram®, Signal®, etc., support different video and voice encoders with different bit rates. The OTT application makes adjustments to the encoder and the communication quality depending on the channel. The subscriber may have subscribed to a lower video call rate, but the subscriber can use the API to adjust the QoS for the OTT application for a fee.

Upon handover of a call, the 5G network maintains and hands over the QoS flow from the source base station to the target base station (i.e., from one Next Generation Node B (gNB) to another). This 5G QoS framework and 5G enhanced mobility (make before break) guarantee the high quality OTT service while supporting mobility.

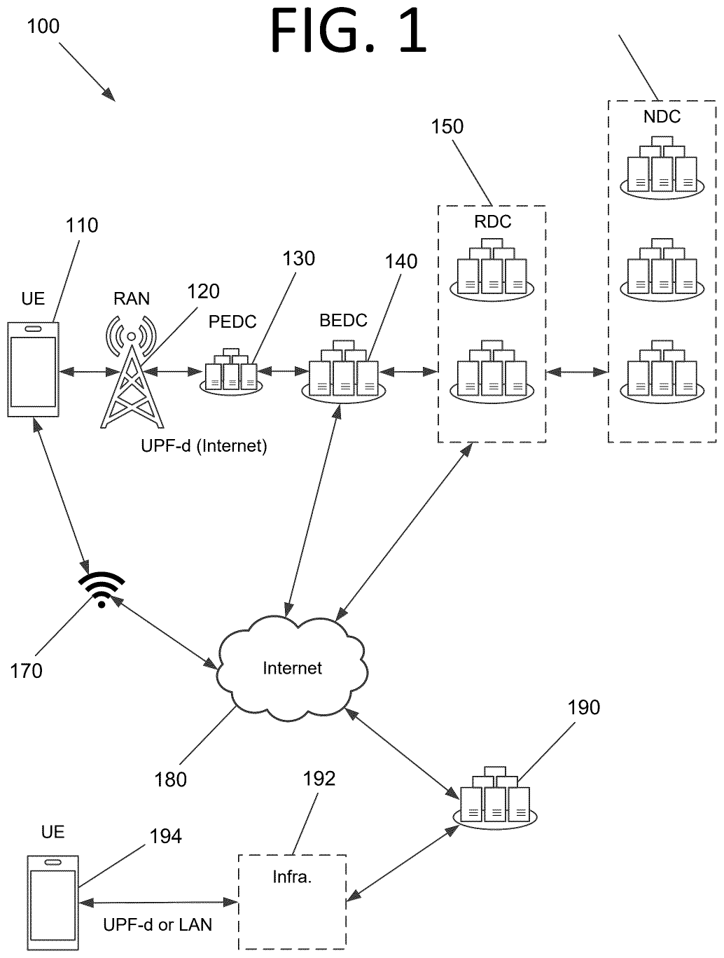

FIG. 1 is an architectural diagram illustrating a telecommunications and OTT application infrastructure system 100. User equipment (UE) 110 (e.g., a mobile phone, a tablet, a laptop computer, a smart watch, etc.) is running an OTT application and communicates with UE 194 that is also running the OTT application. UE 110 can either communicate with UE 194 using UPF data traffic (UPF-d) (uplink communications to and downlink communications from mobile device 194) or via a wireless Local Area Network (LAN) 170. In the case of UPF-d, UE 110 communicates via RAN 120, which sends communications to UE 110, as well as from UE 110 into the core carrier network. In some embodiments, communications are sent to/from RAN 120 via a Performance Edge Data Center (PEDC) 130 to provide lower latency. However, in some embodiments, RAN 120 communicates directly with a Breakout Edge Data Center (BEDC) 140 or an RDC 150. BEDCs are typically smaller data centers that are proximate to the populations they serve. BEDCs may break out UPF-d packets and provide cloud computing resources and cached content to UE 110, such as providing NF application services for gaming, enterprise applications, etc. In certain embodiments, RAN 120 may include a Local Data Center (LDC) (not shown) that hosts one or more Distributed Units (DUs) in a 5G Open RAN (O-RAN) architecture. The Centralized Unit (CU) may be located in the LDC or BEDC 140, for example. LDCs, PEDCs, and/or BEDCs may provide Mobile Edge Computing (MEC) services in some embodiments.

OTT application communications are sent to/from UE 110 via either wireless LAN 170, the Internet 180, OTT application servers 190, infrastructure 192 (e.g., Internet infrastructure, another carrier's network core and RAN, etc.), and the corresponding OTT application on mobile device 194, or via RAN 120, PEDC 130, and BEDC 140 or RDC 150 via the Internet 180 OTT application servers 190, and to infrastructure 192 and the corresponding OTT application on mobile device 194. In some cases, UE 110 and 194 may use UPF-d over the same telecommunications network (i.e., RAN 120, PEDC 130, BEDC 140, and/or RDC 150) if their users are both subscribers.

The carrier network may provide various NFs and other services. For instance, BEDC 140 may provide cloud computing resources and cached content to mobile device 110, such as providing NF application services for gaming, enterprise applications, etc. RDC 150 may provide core network functions, such as UPF-v, UPF-d (if not in BEDC 140, for example), SMF, and AMF functionality. The SMF includes PGW Control Plane (PGW-C) functionality. The UPF includes PGW User Data Plane (PGW-U) functionality.

A National Data Center (NDC) 160 may provide Unified Data Repository (UDR) and user verification services, for example. Other network services that may be provided may include, but are not limited to, IMS+TAS, IP-SM-GW (i.e., the network functionality that provides the messaging service in the IMS network), Location Management Function (LMF), Gateway Mobile Location Center (GMLC)/E-SMLC, HSS+Home Location Register (HLR), HSS+UDM, Authentication Server Function (AUSF), SMSC, Service Communication Proxy (SCP), Security Edge Protection Proxy (SEPP), Network Slice Selection Function (NSSF), and/or PCF functionality. It should be noted that additional and/or different network functionality may be provided without deviating from the present invention. The various functions in these systems may be performed using dockerized clusters in some embodiments.

BEDC 140 may utilize other data centers for NF authentication services. RDC 150 receives NF authentication requests from BEDC 140. RDC 150 may help with managing user traffic latency, for instance. However, RDC 150 may not perform NF authentication in some embodiments. From RDC 150, NF authentication requests may be sent to NDC 160, which may be located far away from UE 110, RAN 120, PEDC 130, BEDC 140, and RDC 150.

As noted above, OTT application communications receive the lowest priority in 5G. As such, any issues arising in the telecommunications network due to congestion, latency, etc., will affect the quality of the OTT application operations, or even prevent the OTT application from working. This can affect both downlink communications to be delivered to the OTT application on mobile device 110 and the uplink communications to be sent from the OTT application on mobile device 110 to the corresponding OTT application on Mobile device 194.

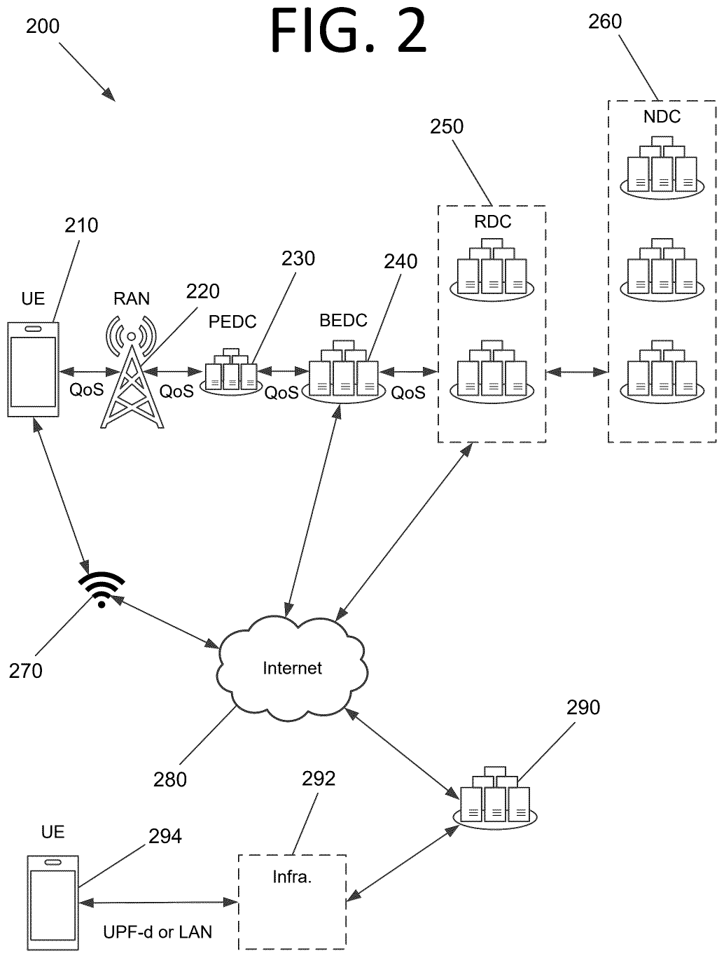

FIG. 2 is an architectural diagram illustrating a telecommunications and OTT application infrastructure system 200 configured to guarantee a QoS flow for UE 210, according to an embodiment of the present invention. Like telecommunications and OTT application infrastructure system 100 of FIG. 1, telecommunications and OTT application infrastructure system 200 includes mobile devices 210, 294, RAN 220, PEDC 230, BEDC 240, RDC 250, NDC 260, a wireless LAN 270, the Internet 280, OTT application servers 290, and infrastructure 292. However, unlike in FIG. 1, mobile device 210 receives a higher quality QoS flow that guarantees good performance for the OTT application. UPF-d packets to/from mobile device 210 are marked with a higher priority and assigned to the appropriate QoS flow(s) to provide good performance for voice, video, group meetings, etc. in the OTT application. This may be done by detecting the OTT application, the OTT service (e.g., using DPI), and/or the bit rate, per the above.

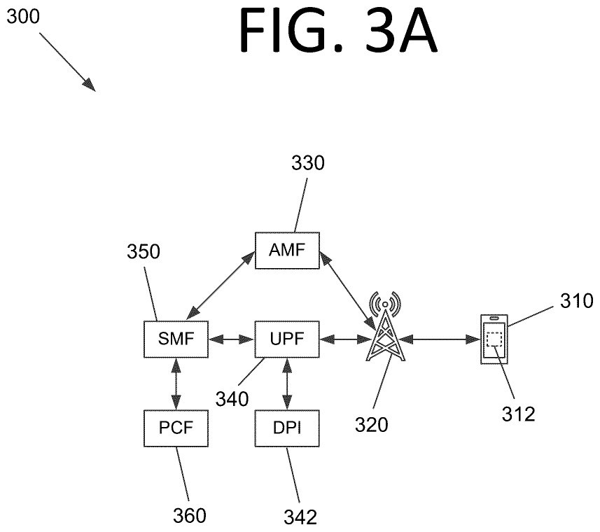

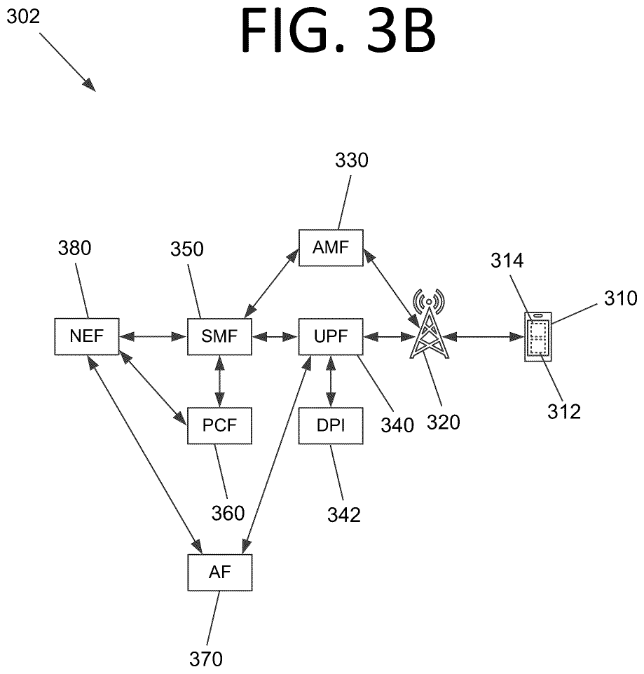

FIG. 3A is an architectural diagram illustrating network elements 300 for providing high QoS flows for OTT applications, according to an embodiment of the present invention. A mobile device 310 is running an OTT application 312 that is using the cellular service of the carrier. However, it is desired to switch the OTT application to a higher QoS flow. A base station 320 (e.g., a gNB) uses the S-NSSAI value(s) requested by mobile device 310 to select an AMF 330. AMF 330 selects the initial slice for mobile device 310. Communications from OTT application 312 via mobile device 310 are initially assigned a low priority QoS flow since they are data communications.

UPF 340 receives the data packets from base station 320 and can detect the OTT application via the App ID. UPF 340 also includes DPI 342, which is performed to determine the type of OTT communication for OTT application 312. The bit rate may also be used to detect the OTT application type and/or the type of communication. In some embodiments, DPI 342 may use AI/ML model(s). Patterns of the communications from OTT application 312 are detected by DPI 342 to provide the appropriate QoS.

The higher QoS flow is used for the OTT service. An enterprise or a subscriber is willing to pay more and receive high quality OTT. For instance, employees of an enterprise can communicate with each other using high quality WhatsApp®.

DPI 342 detects the service type, which is used by UPF 340 to trigger an SMF 350 to request for a PCF 360 to create a QoS flow for high quality OTT communications. Alternatively, DPI can trigger an API to initiate the QoS flow through an NEF (see, e.g., FIG. 3B) and PCF 360. PCF 360 does this by providing information for the QoS flow to SMF 350 in order to create the appropriate SDF template for the QoS flow. This may include rules for specific OTT service types, for example. Once the high quality QoS flow is established or assigned to OTT application 312, the network sends packets to/from OTT application 312 via this QoS flow. In some embodiments, the creation of or assignment to the high quality QoS flow may be performed via an API.

FIG. 3B is an architectural diagram illustrating network elements 302 for requesting high QoS flows for OTT applications, according to an embodiment of the present invention. Here, mobile device 310 is also running a QoS management application 314 that allows mobile device 310 to request a higher quality QoS flow for OTT application 312. To do so, QoS management application 314 uses an application function (AF) 370 provided by the carrier and accessible by QoS management application 314 via UPF 340. AF 370 communicates the request to PCF 360 via an NEF 380. AF 370 may reside anywhere in the network so long as user data information is provided, or even external to the carrier network.

Responsive to the request from QoS management application 314, PCF 360 changes the QoS profile for the subscriber and informs SMF 350. This causes SMF 350 to assign a different SDF template to mobile device 310. AMF 330 changes the QoS flow for mobile device 310 in UPF 340 accordingly, and mobile device 310 begins using the higher QoS flow (e.g., for an additional fee).

An element of the 5G QoS framework that can be used in some embodiments is “Reflective QoS.” Reflective QoS is a new concept introduced in 5G that provides a method to perform QoS in uplink with less signaling between the mobile device and the network core. With Reflective QoS, the mobile device indicates that it supports Reflective QoS during PDU session establishment or modification. When the UPF receives an indication from the SMF to use Reflective QoS for a certain QoS flow, the UPF includes a new field called a Reflective QoS Indicator (RQI) in the encapsulation header of the packets sent to a gNB via an N3 interface.

When the gNB receives the RQI and QFI from the UPF, the gNB indicates this to the mobile device. This causes the mobile device to just monitor the header. Once the RQI is set, the gNB will apply the same QoS in downlink to all uplink data packet transmissions with no specific signaling to tell the mobile device which QoS will be used in uplink.

If a subscriber is initiating an OTT application (e.g., a WhatsApp® call), the first uplink packets of the OTT application will go through best effort QoS (the default flow). The DPI will detect the service type at the UPF towards the application server (over the Internet), initiate the process of creating the QoS flow with Reflective QoS ON (RQI: set), and map the downlink packets to the QoS flow. Since the RQI is set, the mobile device immediately creates the QoS flow on the uplink and routes the subsequent packets of the OTT application to the high QoS flow.

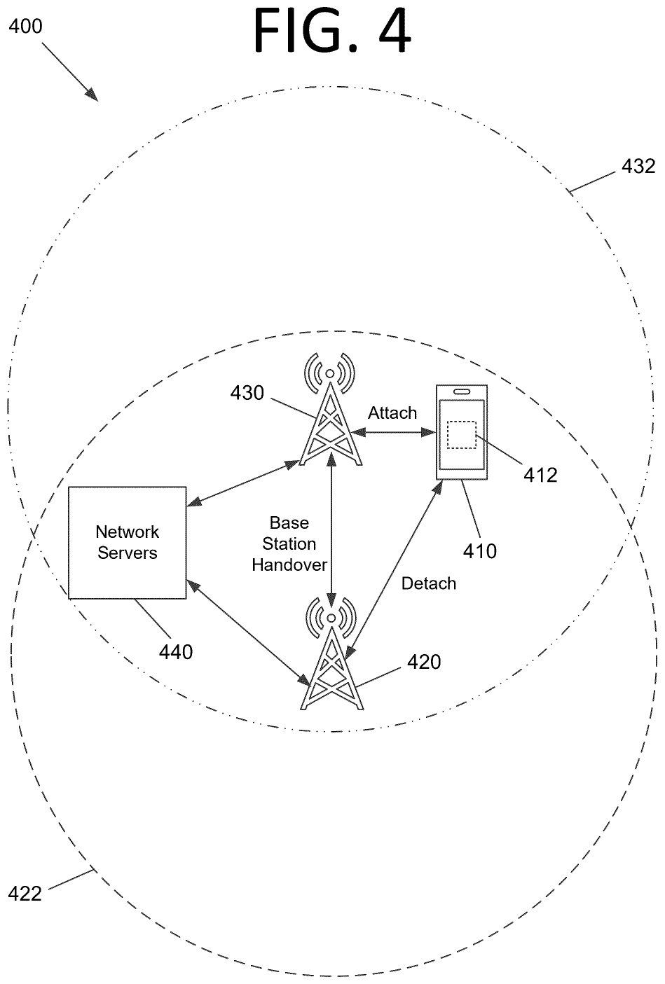

FIG. 4 illustrates a high QoS handover scenario 400, according to an embodiment of the present invention. A mobile device 410 is running an OTT application 412 and has a high QoS flow via base station 420, which has coverage area 422. Another base station 430 has a coverage area 432, and mobile device 410 is located within both coverage area 422 and coverage area 432, which overlap.

Base station 420 sends/receives user plane data for mobile device 410 via network servers 440, which may be servers of an LDC, a PEDC, a BEDC, an RDC, any combination thereof, etc. It should also be noted that while network servers 440 are shown as being within coverage areas 422, 432 for the purposes of FIG. 4, network servers may be in any suitable location(s) without deviating from the scope of the invention. Network servers 440 provide AMF, UPF, DPI, SMF, PCF, etc.

Handover of mobile device 410 from base station 420 and its cell to base station 430 and its cell is desired. This may be due to congestion, movement of mobile device away from base station 420, deteriorating signal characteristics in communications between mobile device 410 and base station 420, etc. The handover may be an Xn-based handover procedure, if supported, or an N2-based handover procedure. N2 is the logical reference point between base stations 420, 430 and the AMF of network servers 440. Handover may be triggered due to a measurement report from mobile device 410 or by base station 420 itself. 5G supports several new enhanced handovers, including conditional handover, Dual Active Protocol Stack (DAPS) handover, and new Rel-18 L1/L2-based handover.

Base station 420 extracts the Target Cell Global Identity from a database of neighbor relations at base station 420. Mobile device 410 may identify the target cell (i.e., cell 432) using a Physical layer Cell Identity (PCI). Base station 420 then maps that PCI onto target cell 432.

Base station 430 is provided with a Globally Unique AMF Identity (GUAMI) by base station 420. This informs base station 430 with the identity of the AMF of network servers 440 that will be used to serve mobile device 410. Mobile device 410 detaches from base station 420 and attaches to base station 430. AMF ensures that an equivalent QoS flow is provided for communications to/from base station 430. The UPF of network servers 440 then sends communications to/receives communications from base station 430 in accordance with this QoS flow.

The high QoS handover scenario differs from traditional handover. Since the OTT application is mapped to a QoS flow with better Allocation and Retention Priority (ARP), the target gNB (i.e., base station 430) will accommodate this traffic even if the target gNB is congested. The target gNB will thus minimize the packet latency and minimize (or if possible, eliminate) packet loss during the handover.

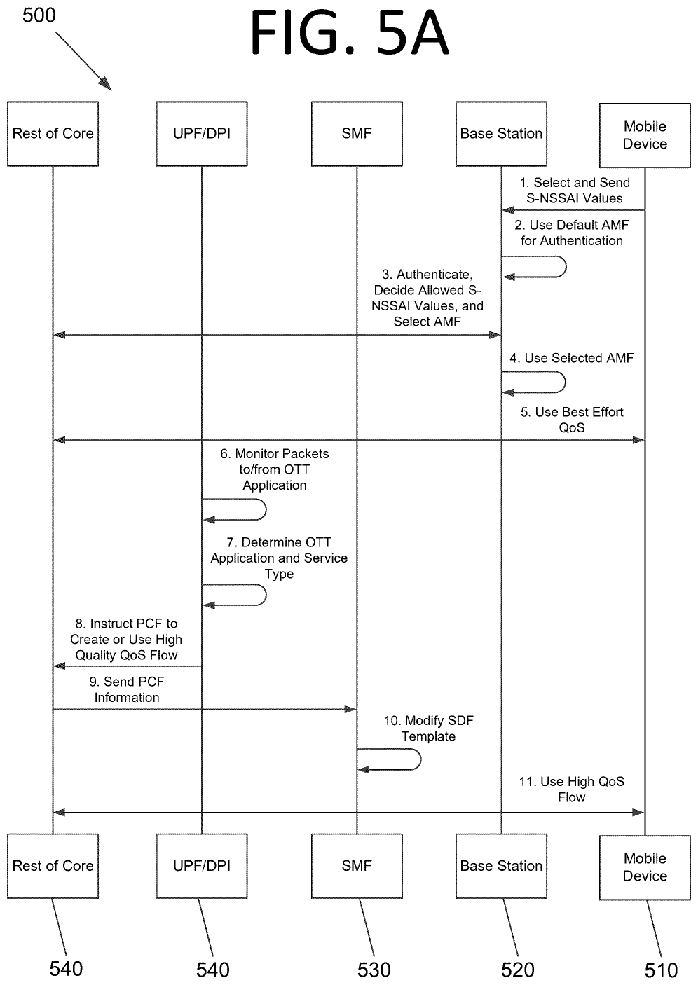

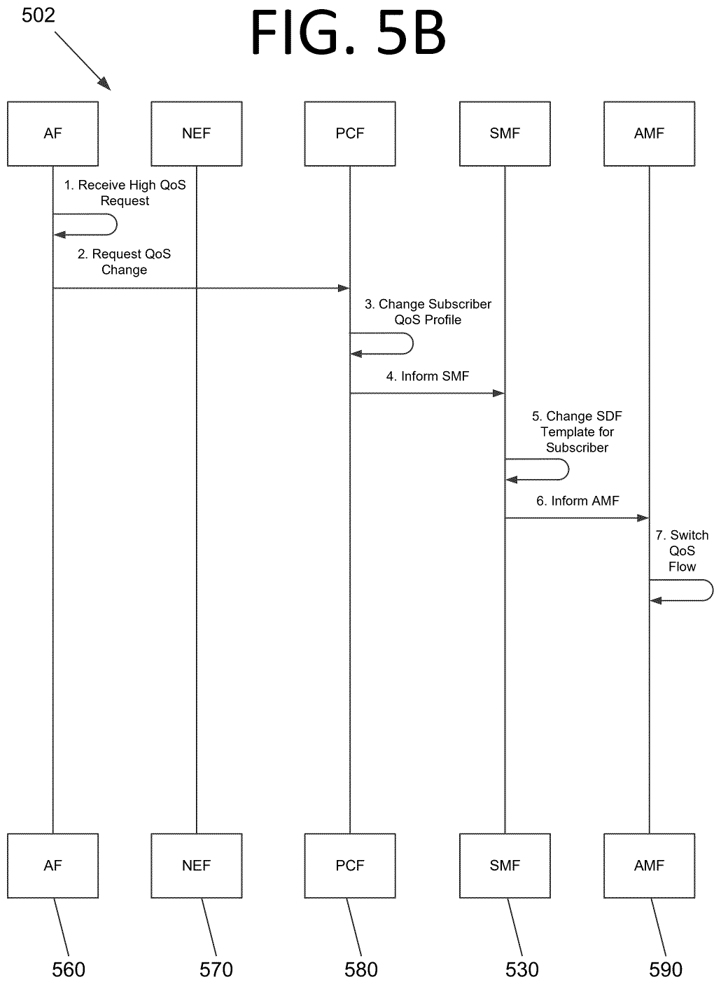

FIG. 5A is a flow diagram illustrating a process 500 for providing high QoS flows for OTT applications, according to an embodiment of the present invention. The process begins with a mobile device selecting and sending S-NSSAI value(s) to a base station 520 to which mobile device 510 is attached. Base station 520 uses a default AMF (which may not be the selected AMF) to perform the authentication process through AUSF & UDM/UDR. The process fetches the subscribed S-NSSAI value(s), and the NSSF will decide the allowed S-NSSAI values and the selected AMF. Base station 520 will then use the selected AMF, which may not be the AMF that mobile device 510 requested.

SDF templates are initiated at an SMF 530 based on the information provided by a PCF, but SMF 530 only communicates with the UPF over the uplink. The SDF templates to gNB 520 or mobile device 530 are from SMF 530 via the AMF through N2 and N1 interfaces. The OTT traffic at mobile device 510 from the best effort (default) flow to the QoS flow requires User Equipment (UE) Route Selection Policies (URSPs) if the OoS is mapped to a different slice. URSPs/Network Slice Selection Policies (NSSPs) are provisioned to mobile device 510 by the PCF.” The network then uses best effort QoS initially for the OTT data communications.

A UPF 540 with DPI monitors data packets sent to from the OTT application via base station 520 and the rest of the core 550. UPF 540 detects the OTT application type using the App ID in the packets (and in some embodiments, also uses the bit rate of the communications). DPI is also used to determine the type of OTT communication for the OTT application (i.e., the service type). This determination may also be informed by the bit rate in some embodiments. Patterns of the communications from the OTT application are detected by the DPI to provide the appropriate QoS for the OTT application and service type.

However, the App ID may not be present for all OTT communications, and the DPI can detect the application type with analytics using signature-based methods, behavior-based methods, or any other suitable types. For instance, several “peer-to-peer” applications try to hide their identity from the service providers and, in response, the service providers utilize DPIs to detect and block these applications. Thus, there may be OTT applications without an App ID, but the DPI will detect them nonetheless. There is a possibility of false detection in this process, and the occurrence of false detection should be minimized to the extent possible.

UPF 540 instructs the PCF of core 550 that a new, higher quality QoS flow should be created for the OTT application. The PCF looks up subscription information pertaining to the subscriber for mobile device 510 and sends this information to SMF 530, which manages all session-related procedures. SMF 530 modifies the respective SDF template accordingly and informs the AMF of this change since SMF 530 does not have connectivity to base station 520 and mobile device 510. As such, the QoS signaling from SMF 530 is relayed to base station 520 and mobile device 510 via the AMF, including the SDF template. The network then sends packets to/from the OTT application and mobile device 510 via this high QoS flow.

In some embodiments, the creation of or assignment to the high quality QoS flow may be performed via an API (e.g., one that calls an AF that uses an NEF to access the PCF, etc.). Per the above, in certain embodiments, Reflective QoS can be used by mobile device 510 for uplink communications to base station 520. If the QoS flow is on a different slice, URSP will be used for routing the OTT traffic to the slice that QoS flow is in.

FIG. 5B is a flow diagram illustrating a process 502 for requesting high QoS flows for OTT applications, according to an embodiment of the present invention. Here, a subscriber's mobile device (not shown) or a computing system associated with an enterprise (also not shown) requests a high QoS flow for an OTT application via an AF 560. AF 560 requests the QoS change from a PCF 580 via an NEF 570.

Responsive to this request, PCF 580 changes the QoS profile for the subscriber and informs SMF 530. This causes SMF 530 to assign a different SDF template to the mobile device and/or OTT application, and SMF 530 informs AMF 590 of the change. AMF 590 changes the QoS flow for the mobile device and informs the base station to which the mobile device is attached. The OTT application, mobile device, and network then use the high QoS flow.

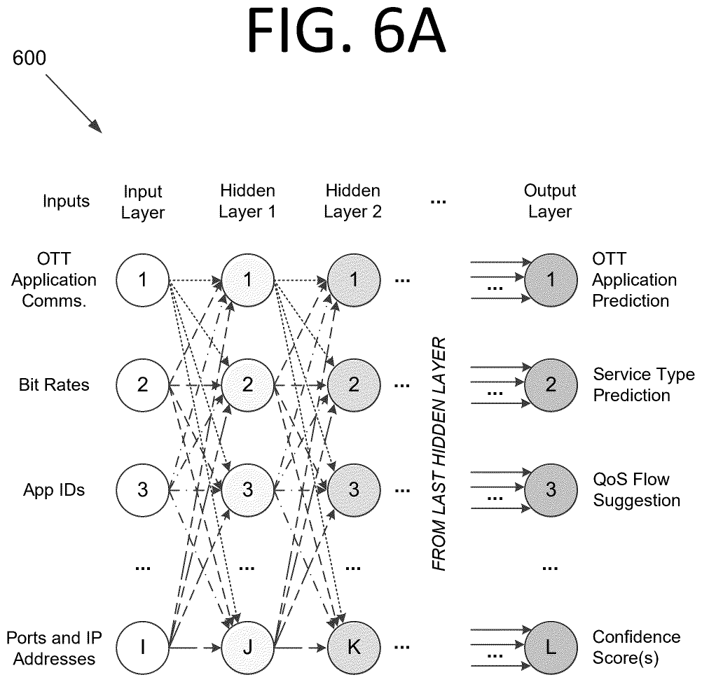

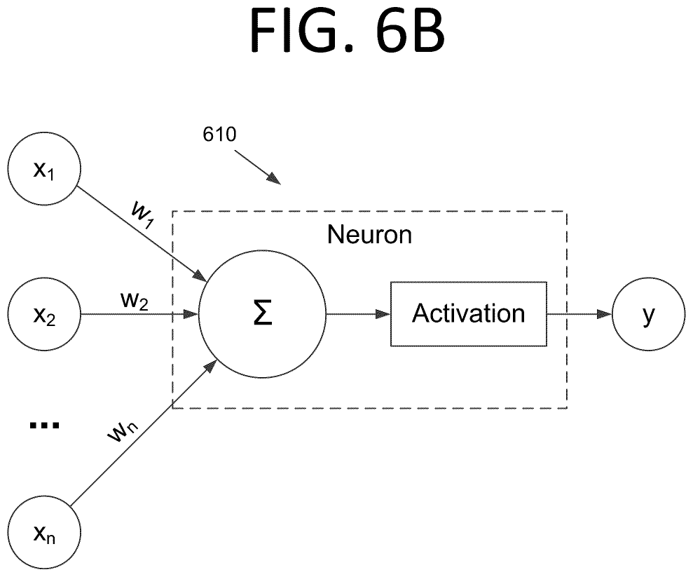

Per the above, AI/ML may be used in some embodiments. Various types of AI/ML models may be trained and deployed without deviating from the scope of the invention. For instance, FIG. 6A illustrates an example of a neural network 600 that has been trained to assist with determining OTT service types for providing appropriate QoS flows for OTT applications, according to an embodiment of the present invention.

Neural network 600 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 6A, recorded OTT application communications, bit rates, App IDs associated with the OTT applications, ports and IP addresses, traffic patterns, packet lengths, and inter-arrival times of consecutive packets or initial packets of the OTT traffic, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. The output layer provides vector embeddings, failing radio predictions, handover issue predictions, confidence scores, etc. It should be noted that numbers of neurons I, J, K, and L are not necessarily equal, and thus, any desired number of layers may be used for a given layer of neural network 600 without deviating from the scope of the invention. Indeed, in certain embodiments, the types of neurons in a given layer may not all be the same. For instance, convolutional neurons, recurrent neurons, and/or transformer neurons may be used.

Neural network 600 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 610 is shown in FIG. 6B. Inputs x₁, x₂, . . . xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 & if \sum wx + bias \geq 0 \\ 0 & if \sum wx + bias < 0\end{matrix} \qquad ( 2 )$$

The output y of neuron 610 may thus be given by:

$$y = f ( x ) {\sum }_{i = 1}^{m} ( {w}_{i} {x}_{i} ) + bias \qquad ( 3 )$$

In this case, neuron 610 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the best core for a give service or application, determining when a network associated with a core is likely to be congested, etc.).

During training, various labeled data is fed through neural network 600. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights W for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(n₁)=ƒ′ⱼ(nⱼ), where nⱼ is the network activity at layer j (i.e., nⱼ=Wⱼoⱼ₋₁+bⱼ) where oⱼ=ƒⱼ(nⱼ) and the apostrophe ′ denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where o denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

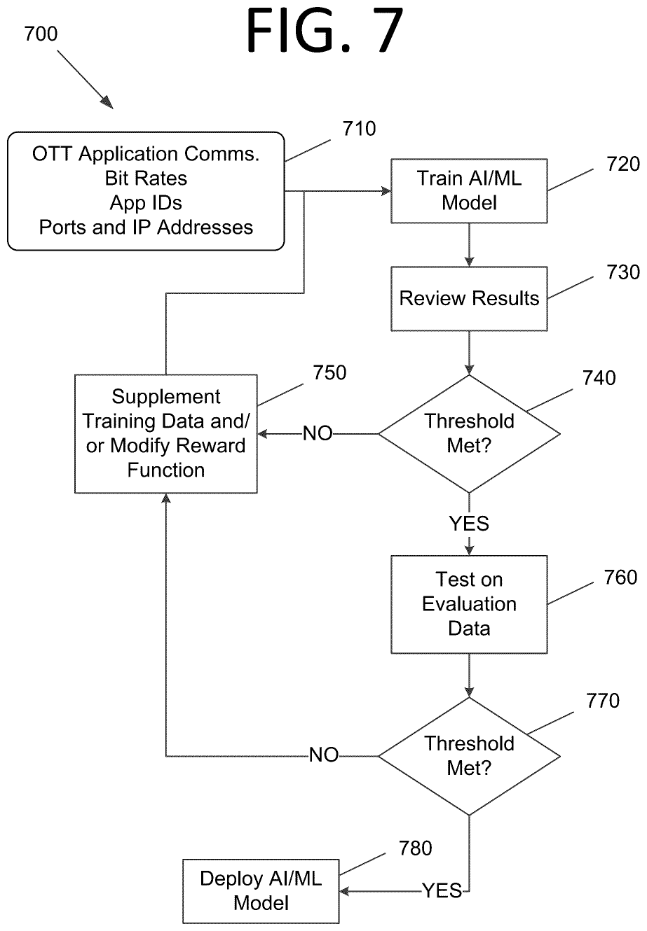

FIG. 7 is a flowchart illustrating a process 700 for training AI/ML model(s), according to an embodiment of the present invention. The process begins with providing recorded OTT application communications, bit rates, App IDs associated with the OTT applications, ports and IP addresses, etc. at 710, whether labeled or unlabeled. Other training data used in addition to or in lieu of the training data shown in FIG. 7, such as traffic patterns, packet lengths, and inter-arrival times of consecutive packets or initial packets of the OTT traffic, etc. Indeed, the nature of the training data that is provided will depend on the objective that the specific AI/ML model is intended to achieve. The AI/ML model is then trained over multiple epochs at 720 and results are reviewed at 730.

If the AI/ML model fails to meet a desired confidence threshold at 740, the training data is supplemented and/or the reward function is modified to help the AI/ML model achieve its objectives better at 750 and the process returns to step 720. If the AI/ML model meets the confidence threshold at 740, the AI/ML model is tested on evaluation data at 760 to ensure that the AI/ML model generalizes well and that the AI/ML model is not over fit with respect to the training data. The evaluation data includes information that the AI/ML model has not processed before. If the confidence threshold is met at 770 for the evaluation data, the AI/ML model is deployed at 780. If not, the process returns to step 750 and the AI/ML model is trained further.

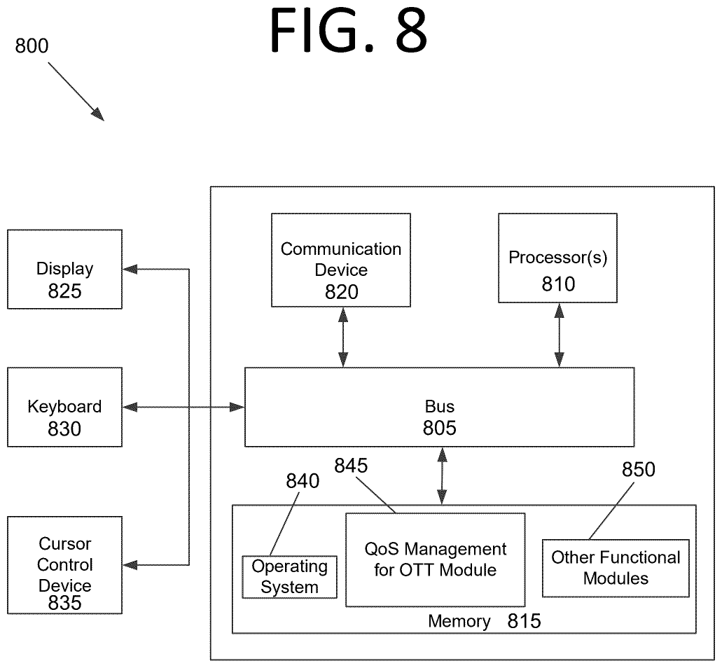

FIG. 8 is an architectural diagram illustrating a computing system 800 configured to perform aspects of providing high quality QoS flows for OTT applications, according to an embodiment of the present invention. In some embodiments, computing system 800 may be one or more of the computing systems depicted and/or described herein, such as a mobile device, a base station, another computing system of a RAN (e.g., a Radio Unit (RU), a DU, or a CU in O-RAN), a computing system of an LDC, a PEDC, a BEDC, an RDC, an NDC, etc. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 810 may also have multiple processing cores, and at least some of the cores may be configured to perform specific functions. Multi-parallel processing may be used in some embodiments. In certain embodiments, at least one of processor(s) 810 may be a neuromorphic circuit that includes processing elements that mimic biological neurons. In some embodiments, neuromorphic circuits may not require the typical components of a Von Neumann computing architecture.

Computing system 800 further includes a memory 815 for storing information and instructions to be executed by processor(s) 810. Memory 815 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both.

Additionally, computing system 800 includes a communication device 820, such as a transceiver, to provide access to a communications network via a wireless and/or wired connection. In some embodiments, communication device 820 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 820 may include one or more antennas that are singular, arrayed, phased, switched, beamforming, beamsteering, a combination thereof, and or any other antenna configuration without deviating from the scope of the invention.

Processor(s) 810 are further coupled via bus 805 to a display 825, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 825 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 830 and a cursor control device 835, such as a computer mouse, a touchpad, etc., are further coupled to bus 805 to enable a user to interface with computing system 800. However, in certain embodiments, a physical keyboard and mouse may not be present, and the user may interact with the device solely through display 825 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously.

Memory 815 stores software modules that provide functionality when executed by processor(s) 810. The modules include an operating system 840 for computing system 800. The modules further include a QoS management for OTT module 845 that is configured to perform all or part of the processes described herein or derivatives thereof. Computing system 800 may include one or more additional functional modules 850 that include additional functionality.

One skilled in the art will appreciate that a “computing system” could be embodied as a server, an embedded computing system, a quantum computing system, or any other suitable computing device or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

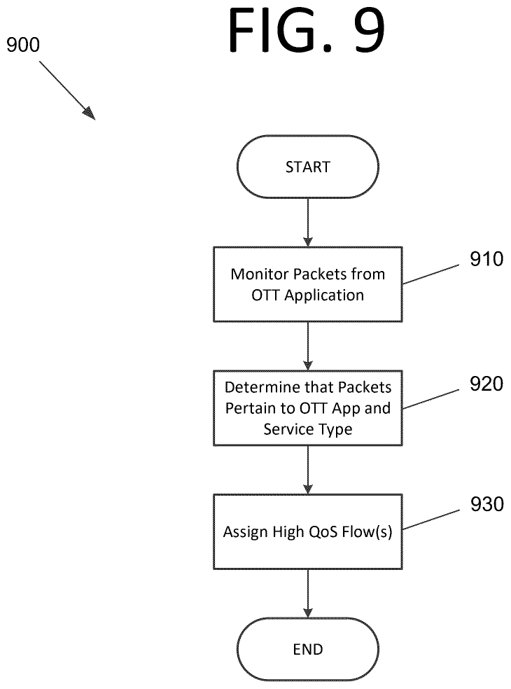

FIG. 9 is a flowchart illustrating a process 900 for providing high QoS flows for OTT applications, according to an embodiment of the present invention. The process begins with monitoring packets from an OTT application executing on a mobile device at 910. In some embodiments, the monitoring of the packets from the OTT application includes performing DPI on the monitored packets to determine patterns and characteristics of communications to and/or from the OTT application, determining one or more service IP addresses and/or one or more ports in the monitored packets that are associated with the OTT application, monitoring a bit rate of the monitored packets, obtaining an App ID from the monitored packets that indicates a type of the OTT application, or any combination thereof.

A UPF determines that the monitored packets pertain to the OTT application and a service type at 920. QoS flow(s) are then created and/or assigned to the OTT application, the mobile device, or both, based on the determined OTT application and service type at 930. The created and/or assigned QoS flow(s) have a higher QoS than an originally assigned QoS flow for OTT data the mobile device. In some embodiments, Reflective QoS is used to set up the QoS flow template on the uplink by setting the RQI in the OTT packet header at the UPF. If the QoS flow for the OTT traffic is on a different slice, URSP will be used at the mobile device to route the OTT traffic to the appropriate slice.

In some embodiments, the created and/or assigned QoS flow(s) provide a guaranteed packet latency, packet drop rate, and packet priority. In some embodiments DPI is used, and the DPI includes using trained AI/ML model(s) that have been trained to learn characteristics of each OTT application type and perform classification of the OTT application and the service type. In certain such embodiments, the AI/ML model(s) are trained based on recorded OTT application communications, service type bit rates, ports and IP addresses of the OTT applications, or any combination thereof.

In some embodiments, the service type of the OTT application includes a voice call, a video, or a group communication and an SDF template is assigned to each service type. In certain embodiments the creating and/or assigning of the QoS flow(s) to the OTT application, the mobile device, or both, is performed by an SMF using one or more SDF templates and the SMF is executing on one or more computing systems of a network core. In some embodiments, the monitoring of the packets from the OTT application is performed by a UPF executing on one or more computing systems of a network core.

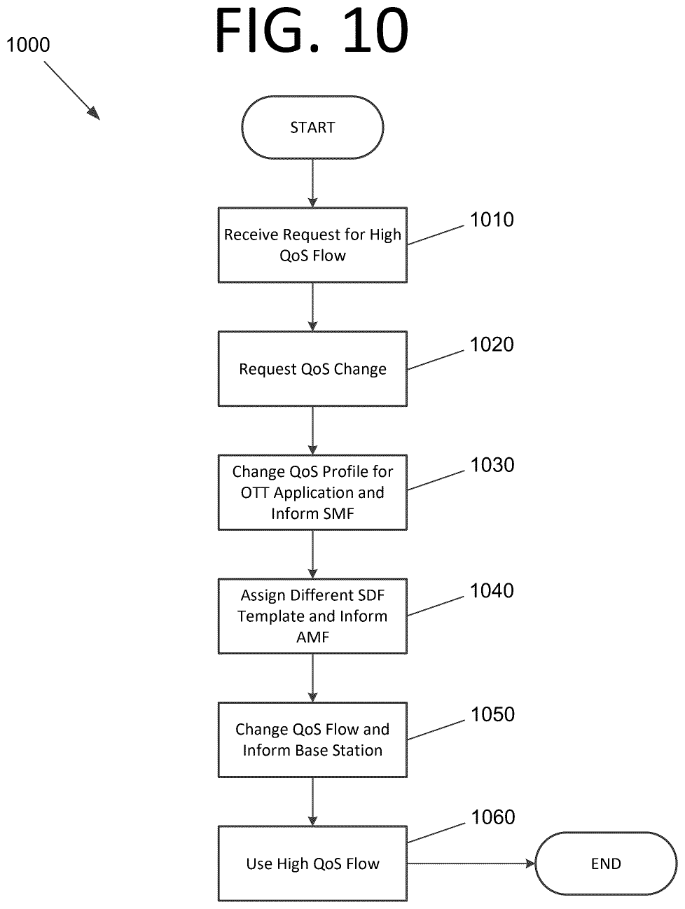

FIG. 10 is a flowchart illustrating a process 1000 for requesting high QoS flows for OTT applications, according to an embodiment of the present invention. The process begins with receiving a request for a high QoS flow for an OTT application by an AF at 1010. The request may come from a mobile device of a subscriber, a computing system of a corporate entity on behalf of an employee, etc. The AF requests a QoS change for the subscriber from a PCF via an NEF at 1020.

Responsive to this request, the PCF changes the QoS profile for the subscriber at and informs an SMF at 1030. This causes the SMF to assign a different SDF template to the mobile device and/or OTT application and inform an AMF of the change at 1040. The AMF changes the QoS flow for the mobile device and/or OTT application for that subscriber and informs the base station to which the mobile device is attached at 1050. The OTT application, mobile device, and network then use the high QoS flow at 1060.

The process steps performed in FIGS. 5A, 5B, 7, 9, and 10 may be performed by computer program(s), encoding instructions for the processor(s) to perform at least part of the process(es) described in FIGS. 5A, 5B, 7, 9, and 10 in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 810 of computing system 800 of FIG. 8) to implement all or part of the process steps described in FIGS. 5A, 5B, 7, 9, and 10 which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs for providing one or more quality of service (QoS) flows for over-the-top (OTT) applications, the one or more computer programs configured to cause at least one processor to:
monitor packets from an OTT application executing on a mobile device;
determine that the monitored packets pertain to the OTT application and a service type; and
create and/or assign one or more QoS flows to the OTT application, the mobile device, or both, based on the determined OTT application and service type, wherein
the one or more created and/or assigned QoS flows have a higher QoS than an originally assigned QoS flow for OTT data the mobile device.

2. The one or more non-transitory computer-readable media of claim 1, wherein the one or more created and/or assigned QoS flows provide a guaranteed packet latency, packet drop rate, and packet priority.

3. The one or more non-transitory computer-readable media of claim 1, wherein the monitoring of the packets from the OTT application comprises performing Deep Packet Inspection (DPI) on the monitored packets to determine patterns and characteristics of communications to and/or from the OTT application.

4. The one or more non-transitory computer-readable media of claim 3, wherein the monitoring of the packets from the OTT application comprises determining one or more service Internet Protocol (IP) addresses and/or one or more ports in the monitored packets that are associated with the OTT application.

5. The one or more non-transitory computer-readable media of claim 3, wherein the monitoring of the packets from the OTT application comprises monitoring a bit rate of the monitored packets.

6. The one or more non-transitory computer-readable media of claim 3, wherein the DPI comprises using one or more trained artificial intelligence (AI)/machine learning (ML) models that have been trained to learn characteristics of each OTT application type and perform classification of the OTT application and the service type.

7. The one or more non-transitory computer-readable media of claim 6, wherein the one or more AI/ML models are trained based on recorded OTT application communications, service type bit rates, ports and IP addresses of the OTT applications, or any combination thereof.

8. The one or more non-transitory computer-readable media of claim 1, wherein the monitoring of the packets from the OTT application comprises obtaining a 5G Application Identifier (App ID) from the monitored packets that indicates a type of the OTT application.

9. The one or more non-transitory computer-readable media of claim 1, wherein
the service type of the OTT application comprises a voice call, a video, or a group communication, and
a Service Data Flow (SDF) template is assigned to each service type.

10. The one or more non-transitory computer-readable media of claim 1, wherein
the creating and/or assigning of the one or more QoS flows to the OTT application, the mobile device, or both, is performed by a Session Management Function (SMF) using one or more Service Data Flow (SDF) templates based on policy information from a Policy Control Function (PCF), and
the SMF and PCF are executing on one or more computing systems of a network core.

11. The one or more non-transitory computer-readable media of claim 10, wherein Reflective QoS is used for uplink communications from the mobile device.

12. The one or more non-transitory computer-readable media of claim 10, wherein User Equipment (UE) Route Selection Policy (URSP) is used by the mobile device for routing packets of the OTT application to an appropriate slice.

13. The one or more non-transitory computer-readable media of claim 1, wherein
the monitoring of the packets from the OTT application is performed by a User Plane Function (UPF), and
the UPF is executing on one or more computing systems of a network core.

14. One or more computing systems, comprising:
memory storing computer program instructions for providing one or more quality of service (QoS) flows for over-the-top (OTT) applications; and
at least one processor configured to execute the computer program instructions, wherein the computer instructions are configured to cause the at least one processor to:
monitor packets from an OTT application executing on a mobile device by a User Plane Function (UPF) that utilizes Deep Packet Inspection (DPI) on the monitored packets to determine patterns and characteristics of communications to and/or from the OTT application;
determine, by the UPF, that the monitored packets pertain to the OTT application and a service type; and
create and/or assign one or more QoS flows to the OTT application, the mobile device, or both, based on the determined OTT application and service type, wherein
the one or more created and/or assigned QoS flows have a higher QoS than an originally assigned QoS flow for OTT data the mobile device.

15. The one or more computing systems of claim 14, wherein
the DPI comprises using one or more trained artificial intelligence (AI)/machine learning (ML) models that have been trained to learn characteristics of each OTT application type and perform classification of the OTT application and the service type, and
the one or more AI/ML models are trained based on recorded OTT application communications, service type bit rates, ports and IP addresses of the OTT applications, or any combination thereof.

16. The one or more computing systems of claim 14, wherein
Reflective QoS is used for uplink communications from the mobile device, and
User Equipment (UE) Route Selection Policy (URSP) is used by the mobile device for routing packets of the OTT application to an appropriate slice.

17. A computer-implemented method for providing one or more quality of service (QoS) flows for over-the-top (OTT) applications, comprising:
monitoring packets from an OTT application executing on a mobile device, by a User Plane Function (UPF);
determining that the monitored packets pertains to the OTT application and a service type, by the UPF; and
creating and/or assigning one or more QoS flows to the OTT application, the mobile device, or both, based on the determined OTT application and service type, by a Session Management Function (SMF) using one or more Service Data Flow (SDF) templates based on policy information from a Policy Control Function (PCF), wherein
the one or more created and/or assigned QoS flows have a higher QoS than an originally assigned QoS flow for OTT data the mobile device,
the one or more created and/or assigned QoS flows provide a guaranteed packet latency, packet drop rate, and packet priority, and
the UPF, the SMF, and the PCF are executing on one or more computing systems of a network core.

18. The computer-implemented method of claim 17, wherein the monitoring of the packets from the OTT application comprises performing Deep Packet Inspection (DPI) on the monitored packets to determine patterns and characteristics of communications to and/or from the OTT application, determining one or more service Internet Protocol (IP) addresses and/or one or more ports in the monitored packets that are associated with the OTT application, monitoring a bit rate of the monitored packets, or any combination thereof.

19. The computer-implemented method of claim 17, wherein
the monitoring of the packets from the OTT application comprises performing Deep Packet Inspection (DPI) on the monitored packets to determine patterns and characteristics of communications to and/or from the OTT application,
the DPI comprises using one or more trained artificial intelligence (AI)/machine learning (ML) models that have been trained to learn characteristics of each OTT application type and perform classification of the OTT application and the service type, and
the one or more AI/ML models are trained based on recorded OTT application communications, service type bit rates, ports and IP addresses of the OTT applications, or any combination thereof.

20. The computer-implemented method of claim 17, wherein
Reflective QoS is used for uplink communications from the mobile device, and
User Equipment (UE) Route Selection Policy (URSP) is used by the mobile device for routing packets of the OTT application to an appropriate slice.
